(19) United States
(12) Patent Application Publication
(10) Pub. No.: US 2009/0204934 A1
(43) Pub. Date: Aug. 13, 2009

(54) METHOD FOR COMPENSATING LENGTH OF DIFFERENTIAL PAIR AND METHOD FOR CALCULATING COMPENSATION LENGTH THEREOF AND COMPUTER ACCESSIBLE STORAGE MEDIA

(75) Inventor: Yu-Sen Lin, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/030,667

(22) Filed: Feb. 13, 2008

(51) Int. Cl. G06F 17/50

(52) U.S. Cl. 716/14

(57) ABSTRACT

A method for compensating length of differential pair and a method for calculating compensation length of the zigzagging type delay line thereof are provided. The method for calculating compensation length of the zigzagging type delay line includes following steps. The quantity A of hypotenuse and the quantity B of bends of the zigzagging type delay line are counted. The width W of the zigzagging type delay line is measured. The height S₁ of the parallel line segment of the zigzagging type delay line is measured. An equation

$${L}_{diff} = A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \}$$

is calculated for calculating the compensation length L_{diff} of the zigzagging type delay line.

### BACKGROUND OF THE INVENTION

1. Field of the Invention

The present invention generally relates to a circuit layout, in particular, to a method for compensating length of differential pair and a method for calculating compensation length of a zigzagging type delay line.

2. Description of Related Art

With the progressing of the technology, working frequencies of digital circuits are increasing, thus many undesired electromagnetic effects are generated. Taking a printed circuit board (PCB) as an example, when a signal is transmitted on a transmission line, as an electromagnetic wave is transmitted outward through a medium, an electromagnetic radiation is generated. The electromagnetic radiation affects the normal operation of other electronic elements, which is the so-called electromagnetic interference (EMI). In the existing digital circuit, unit density of elements is increasing continuously, thus many challenges are encountered in circuit design of PCB. In actually wiring, a critical pair (such as a differential pair) has unequal-length paths due to bends and other factors.

FIG. 1 is a layout view of a circuit having a differential pair. P11 and P12 in FIG. 1 represent two circuits in a differential pair respectively. When P11 and P12 of the differential pair pass through a bend, the length of the signal path of the outer circuit P11 is obviously greater than that of the inner circuit P12. A phase skew caused by the difference in the path lengths generates a common mode noise, thereby affecting the integrity of the signal and generating a source of EMI. Therefore, in order to ensure the critical circuit paths to have equal lengths, a circuit design of serpentine is generally used to compensate the path length of the inner circuit P12.

The path length of the circuit is estimated by using a middle line (as shown by the dash line in FIG. 1) of the circuit for the serpentine in conventional art. Such a method seems reasonable, but the actual current will not flow along the middle line of the circuit. According to the common technique, the circuit layout cannot achieve the requirement of the actual signal paths with equal lengths, thus forming a non-negligible common mode noise.

### SUMMARY OF THE INVENTION

Accordingly, the present invention is directed to a method for calculating compensation length of a zigzagging type delay line to accurately calculate compensation length of an actual signal path in the zigzagging type delay line.

The present invention is further directed to a method for compensating length of differential pair to more accurately design a differential pair having actual signal paths with equal lengths.

The present invention provides a method for calculating compensation length of a zigzagging type delay line. The method for calculating compensation length includes the following steps. A quantity A of hypotenuse of the zigzagging type delay line is counted. A quantity B of bends of the zigzagging type delay line is counted. A width W of the zigzagging type delay line is measured. A height S₁ of a parallel line segment of the zigzagging type delay line is measured. An equation

$${L}_{diff} = A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \} is$$

calculated for calculating the compensation length L_{diff} of the zigzagging type delay line.

The present invention provides a method for compensating length of differential pair. The method for compensating length includes the following steps. A quantity A of hypotenuse of a zigzagging type delay line is set. A quantity B of bends of the zigzagging type delay line is set. A width W of the zigzagging type delay line is set. An equation

$$A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \} = 0$$

is calculated for calculating a height S₁ of a parallel line segment of the zigzagging type delay line. The height S₁ of the parallel line segment of the zigzagging type delay line is set. Near a bend of the differential pair, the zigzagging type delay line is disposed in an inner line of the differential pair.

The present invention further provides a computer accessible storage media for storing a computer program. The computer program is loaded in a computer system, such that the computer system executes the above mentioned methods.

As the present invention utilizes the physical geometric structure of the zigzagging type delay line to analyze the actual current trend, so as to deduce a more accurate method for compensating length and a method for calculating compensation length, and thus the compensation length of the actual signal path in the zigzagging type delay line can be accurately calculated, thereby more accurately designing a differential pair having actual signal paths with equal lengths.

In order to make the features and advantages of the present invention more clear and understandable, the following embodiments are illustrated in detail with reference to the appended drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a layout view of a circuit having a differential pair.

FIG. 2 is a layout of a differential pair according to an embodiment of the present invention.

FIG. 3A is a layout of a verification circuit according to an embodiment of the present invention.

FIG. 3B is a cross-sectional view of FIG. 3A.

FIG. 3C is a layout of a differential bend of 45 degrees in FIG. 3A.

FIG. 4 shows simulation results of common mode noise without compensating length and adding the zigzagging type delay line in the differential pair according to an embodiment of the present invention.

FIG. 5 is a flow chart of processes of a method for compensating length of differential pair according to an embodiment of the present invention.

FIG. 6 shows simulation results of common mode noise without compensating length and adding the zigzagging type delay line in the differential pair according to an embodiment of the present invention.

FIG. 7 shows simulation results of a differential-to-common-mode-conversion response in frequency domain without compensating length and adding the zigzagging type delay line in the differential pair according to an embodiment of the present invention.

FIG. 8 shows a method for calculating compensation length of the zigzagging type delay line according to an embodiment of the present invention.

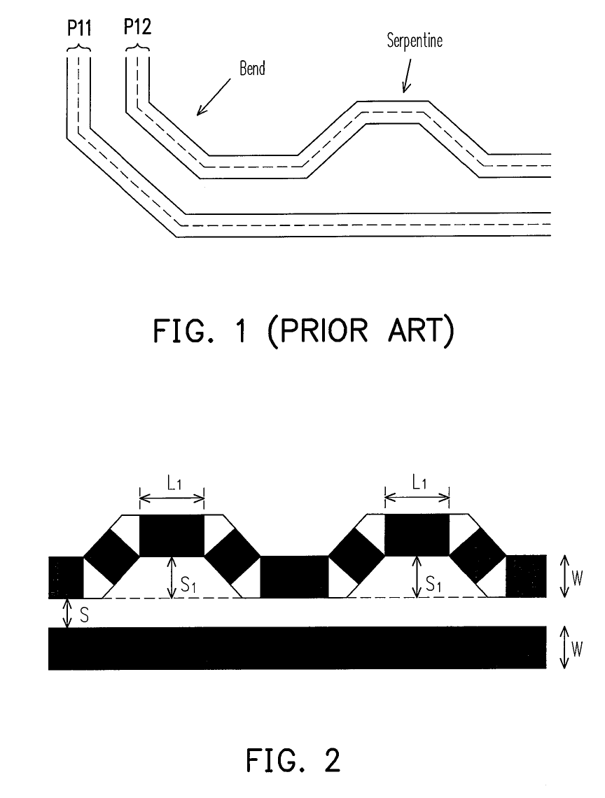

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The following embodiments will be provided to illustrate the present invention. Those of ordinary skill in the art can understand and implement the present invention according to the embodiments. Definitely, the embodiments can also be implemented in the manner of a computer program, and the computer program is stored in a computer accessible storage media, such that the computer executes the following methods.

In the following embodiments, the zigzagging type delay line is implemented as a serpentine. This embodiment analyzes the actual current trend to deduce a more accurate equation, so as to accurately calculate the compensation length of actual signal path in the zigzagging type delay line, thereby more accurately designing a differential pair having actual signal paths with equal lengths.

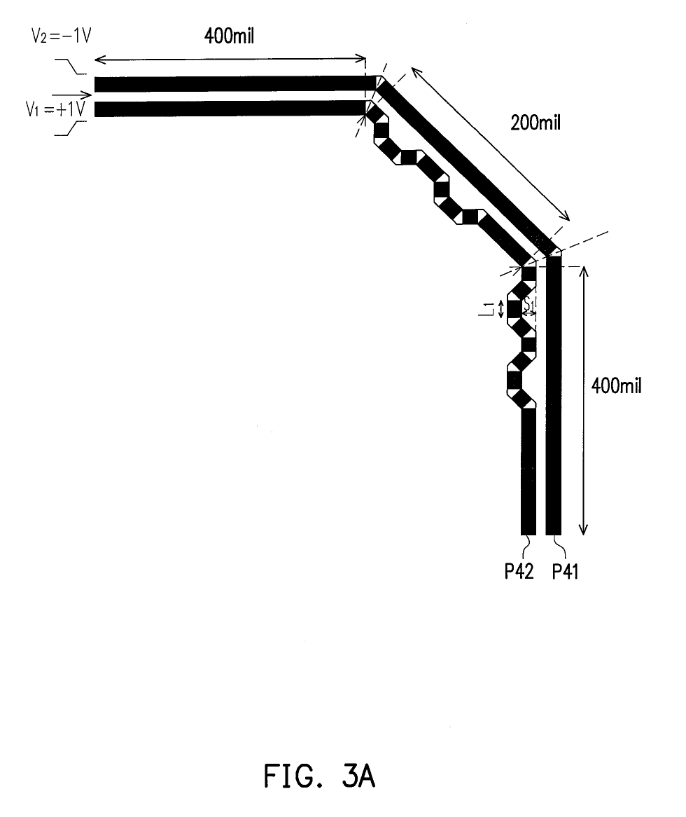

FIG. 2 is a layout of a differential pair according to an embodiment of the present invention, in which a zigzagging type delay line is disposed in one circuit of the differential pair. When the differential signal encounter a bend during the transmission in the circuit, as the structure of the bend is not continuous, a reflection noise of the differential is generated at a driving end. As the length is not equal to each other, a time difference exits between two signals, a common mode noise is generated at a receiving end. In order not to deteriorate the differential reflection caused by the whole, this embodiment set a height S₁ of a parallel line segment of the zigzagging type delay line to be approximately equal to a pitch S of the differential pair. Further, L₁ in FIG. 2 represents the length of the parallel line segment, and W represents the width of the differential pair (i.e., the width of the zigzagging type delay line).

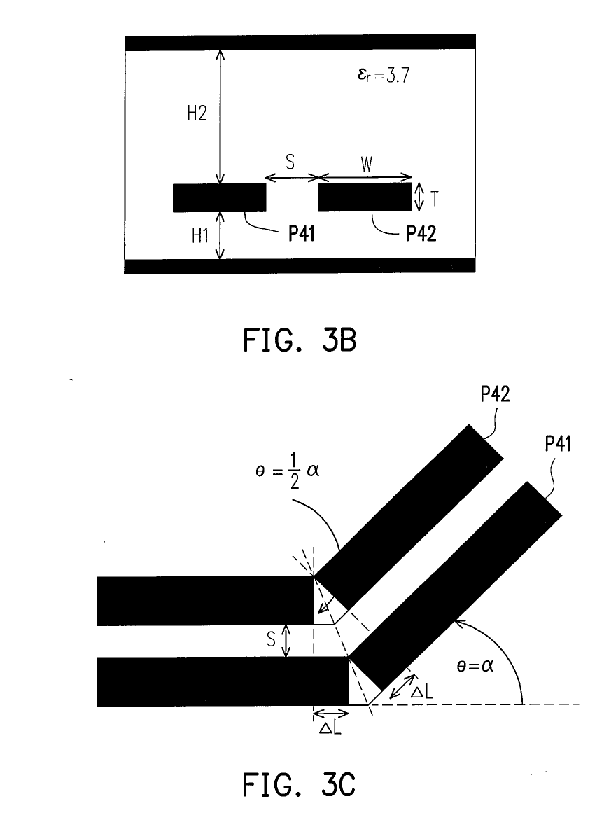

Under such conditions, this embodiment compensates each differential bend by a zigzagging type delay line having two bends. FIG. 3A is a layout of a verification circuit according to an embodiment of the present invention. FIG. 3B is a cross-sectional view of FIG. 3A. Herein, it is assumed that the pitch S of the differential pair in FIG. 3B is 9 mil, and the width W is 4 mil, a circuit thickness T is 1.2 mil, a distance H1 from the differential pair to a lower metal layer is 4 mil, a distance H2 from the differential pair to an upper metal layer is 13.2 mil, and a dielectric coefficient εᵣ of the PCB is 3.7. A time-domain analysis of the layout of the verification circuit in FIG. 3A is performed, to observe the inhibition of the receiving end on the common mode noise. In FIG. 3A, the driving end transmits a positive voltage signal by a circuit P42 and transmits a negative voltage signal by the other circuit P41. The voltage amplitude is about 1 volt, the signal rising time is 50 ps, and the length L₁ of each parallel line segment of the zigzagging type delay line is 3 W (which is three times of the width).

FIG. 3C is a layout of a differential bend of 45 degrees in FIG. 3A. A geometric analysis is performed on FIG. 3C, and the length difference of the 45-degree differential bend of the verification circuit is

2ΔL=2(W+S)tan(θ/2)=10.7696 mil Formula (1),

in which θ is 45 degrees. It can be known that, when the length difference of the 45-degree differential bend is known, under the conditions of length matching (the length is calculated by using the middle line), the height S₁ of the parallel line segment of the zigzagging type delay line having two bends is

10.7696=4(\sqrt{2}−1)S₁ Formula (2),

and thus S₁ is 6.5 mil.

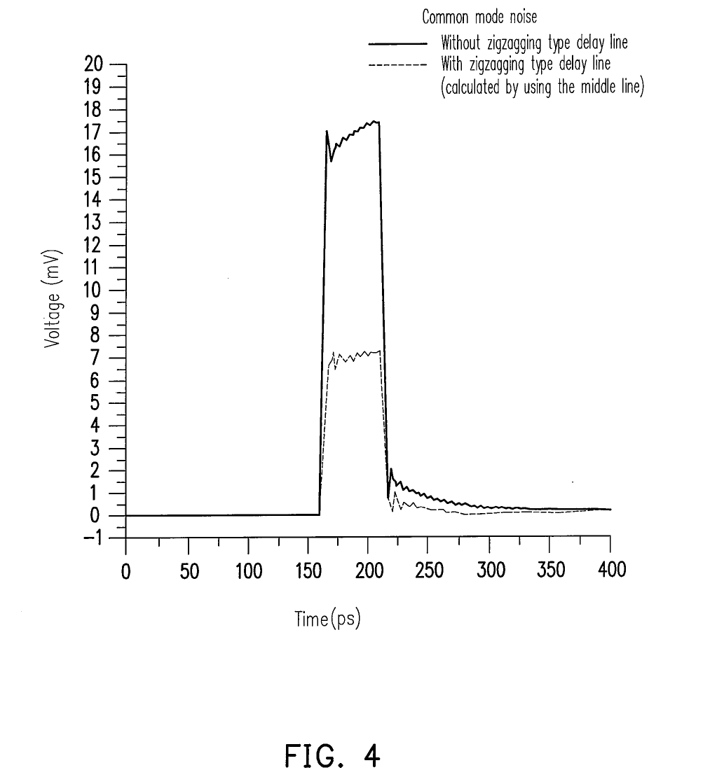

FIG. 4 shows simulation results of common mode noise without compensating length and adding the zigzagging type delay line in a differential pair according to an embodiment of the present invention. The verification circuit of the differential pair in FIGS. 3A and 3B has two differential bends. If the length difference of the differential pair is not compensated (that is, similar to the circuit layout in FIG. 3A but no zigzagging type delay line is disposed), the simulation results show a considerable large common mode noise (a solid curve in FIG. 4). If a zigzagging type delay line is disposed in the differential pair (a circuit layout in FIG. 3A) to compensate the length difference, the simulation results show a significantly reduced common mode noise (a dashed curve in FIG. 4). It should be noted that, the middle line of the zigzagging type delay line is used to calculate the compensation length herein. According to the assumption of the verification conditions, it can be calculated that, when calculating the compensation length by using the middle line, the height S₁ of the parallel line segment of the zigzagging type delay line is 6.5 mil. It can be seen from the dashed curve in FIG. 4 that, if the height S₁ of the parallel line segment of the zigzagging type delay line is 6.5 mil, although the common mode noise is significantly reduced, a non-negligible amount of the common mode noise still exits.

In other words, it can be seen from the simulation results in FIG. 4 that, according to the common method of calculating the compensation length of the zigzagging type delay line by using the middle line, the amount of the common mode noise cannot be reduced to a minimum after the compensation (it can be seen from FIG. 4 that some of the component of the common mode noise is not completely inhibited). Therefore, a difference still exits between the compensation length for the zigzagging type delay line calculated by using the middle line and the length actually required to compensate.

Therefore, this embodiment analyzes the actual current trend to deduce a more accurate equation, so as to accurately calculate the compensation length of actual signal path in the zigzagging type delay line, thereby more accurately designing a differential pair having actual signal paths with equal lengths.

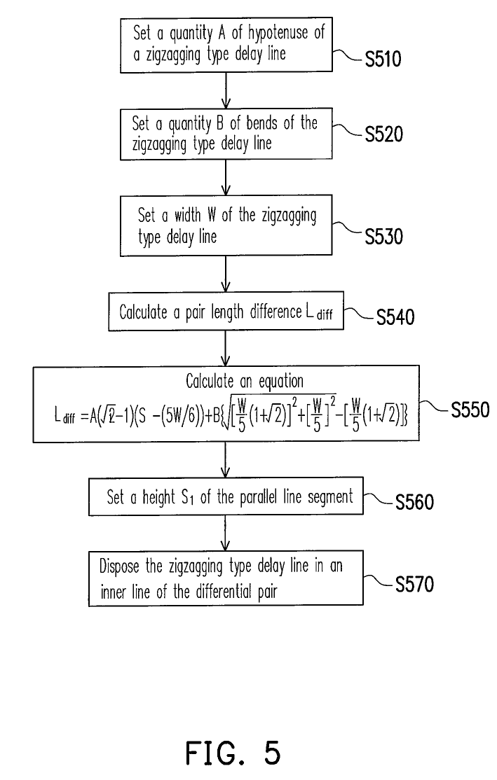

FIG. 5 is a flow chart of a method for compensating length of differential pair according to an embodiment of the present invention. Referring to FIG. 5, first, a quantity A of hypotenuse (Step S510), a quantity B of bends (Step S520), and a width W (Step S530) of a zigzagging type delay line are set by a user. Steps S510-S530 can also be automatically set by a default value of an application program.

In Step S540, a pair length difference L_{diff} formed by the differential pair at a bend (or some bonds) is calculated. In this embodiment, in Step S540, the Formula (1) is used to calculate the pair length difference L_{diff}, that is, calculate L_{diff}=2(W+S)tan(θ/2). For example, if the verification conditions (W=4 mil, S=9 mil, θ=45 degrees) are used, a 45-degree bend enables the differential pair to form a pair length difference L_{diff}=10.7696 mil. Next, in Step S550, an equation

$${L}_{diff} = A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \} \qquad Formula ( 3 )$$

is calculated for calculating the height S₁ of the parallel line segment of the zigzagging type delay line. It can be known from Formula (1) and FIG. 3C that, the differential pair will causes the length difference L_{diff} after passing through the 45-degree bend. Under the conditions of length matching, and with the consideration that the current will flow along the “shortest path”, it is assumed that the parameters set in Steps S510-S530 in FIG. 5 are A=4, B=8, W=4 mil, and the calculation result of Step S550 is S₁=9.1 mil. Then, according to the calculation result of Step S550, the height S₁ of the parallel line segment of the zigzagging type delay line is set (Step S560). Finally, in Step S570, according to the parameter setting, near the bend of the differential pair, the zigzagging type delay line is disposed in an inner line P42 of the differential pair (as shown in FIG. 3A).

In order to verify whether this embodiment can improve the calculation of the compensation length by using the middle line conventionally, Formulas (2) and (3) are applied in the verification circuit shown in FIGS. 3A and 3B respectively. That is, the height S₁ of the parallel line segment obtained by calculating the compensation length by using the middle line is 6.5 mil, and the height S₁ of the parallel line segment obtained by calculating the compensation length according to this embodiment is 9.1 mil, and the zigzagging type delay lines formed by both are verified respectively to compare the difference in the common mode noise inhibition therebetween.

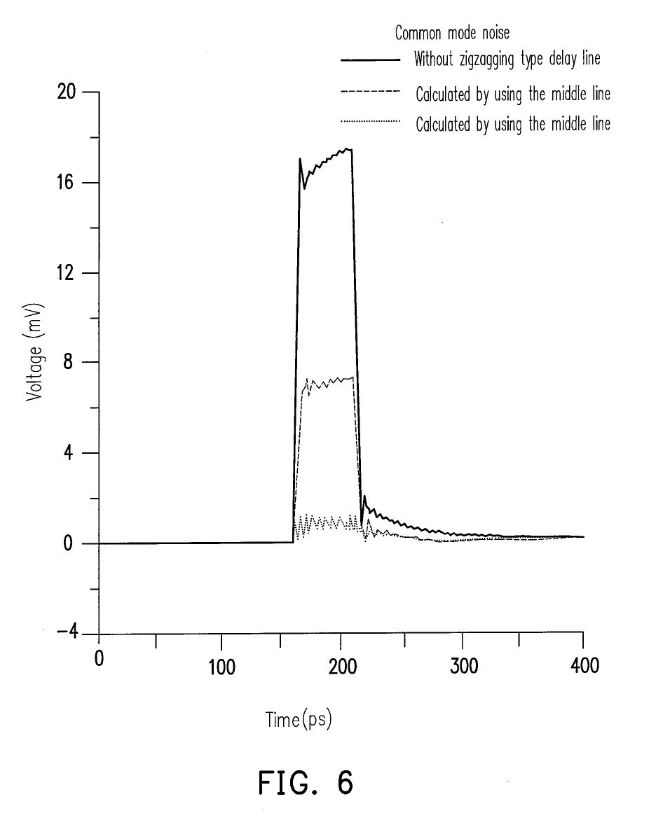

FIG. 6 shows simulation results of common mode noise without compensating length and adding the zigzagging type delay line in the differential pair according to an embodiment of the present invention. The verification circuit of the differential pair shown in FIGS. 3A and FIG. 3B are used to perform simulation. If the length difference of the differential pair is not compensated (similar to the circuit layout in FIG. 3A, but without a zigzagging type delay line disposed), the simulation results show a considerable large common mode noise (a solid curve in FIG. 6). If a zigzagging type delay line is disposed in the differential pair (a circuit layout in FIG. 3A) to compensate the length difference, the simulation results show a significantly reduced common mode noise (a dashed curve and dot curve in FIG. 6). It should be noted that, the dashed curve is obtained by calculating the high S₁=6.5 mil of the parallel line segment by using the middle line of the zigzagging type delay line, while the dot curve is obtained by calculating the high S₁=9.1 mil of the parallel line segment according to the method illustrated in this embodiment and in FIG. 5. It can be seen from the dashed curve in FIG. 6 that, if the height S₁ of the parallel line segment of the zigzagging type delay line is 6.5 mil, although the common mode noise is significantly reduced, a non-negligible amount of the common mode noise still exits. While for the dot curve in FIG. 6, if the height S₁ of the parallel line segment of the zigzagging type delay line is 9.1 mil, the amount of the common mode noise is reduced to the minimum, and thus more accurately realizing the purpose of “equal-length circuit”.

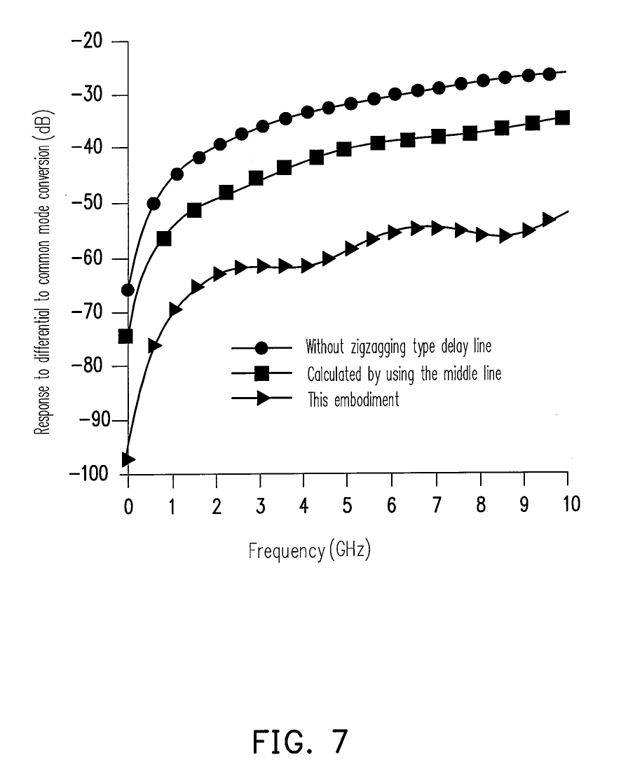

FIG. 7 shows simulation results of a differential-to-common-mode-conversion response in frequency domain without compensating length and adding the zigzagging type delay line in the differential pair according to an embodiment of the present invention. It can be seen from the simulation results that, according to the common method of calculating the compensation length of the zigzagging type delay line by using the middle line, the amount of the common mode noise cannot be reduced to the minimum after the compensation.-(some of the component of the common mode noise is not completely inhibited). The height S₁ of the parallel line segment calculated according to the method illustrated in this embodiment and in FIG. 5 can more accurately realizing the purpose of “equal-length circuit”, regardless the exhibition in time domain or frequency domain.

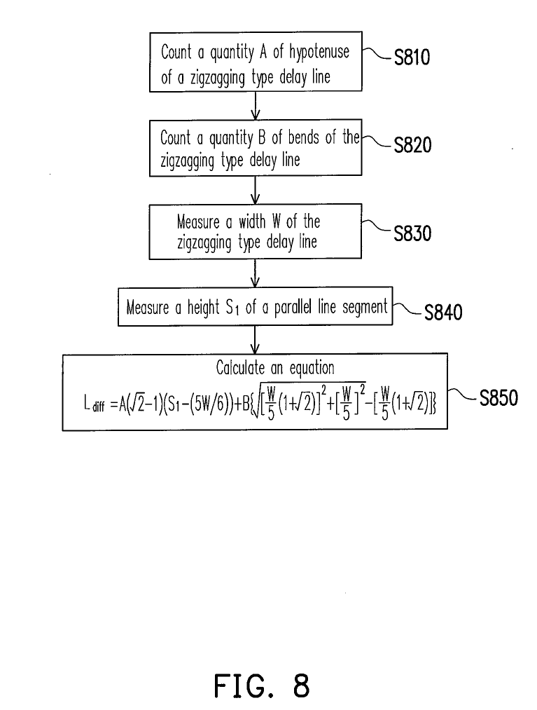

FIG. 8 shows a method for calculating compensation length of the zigzagging type delay line according to an embodiment of the present invention. The compensation length for the zigzagging type delay line is generally required to be corresponding to the length difference L_{diff} of the differential pair. The length difference L_{diff} may be caused by the 45-degree bend or other reasons. Herein, the compensation length is considered to be equal to the length difference L_{diff}. First, the quantity A of hypotenuse (Step S810) and the quantity B of bends (Step S820) of the zigzagging type delay line are counted, and the width W of the zigzagging type delay line (Step S830)and the height S₁ of the parallel line segment (Step S840) are measured. Next, in Step S850, the equation (3) is calculated for calculating the length difference L_{diff} of the zigzagging type delay line. For example, as shown in FIG. 2, the quantity A of hypotenuse of the zigzagging type delay line is 4, and the quantity B of bends is 8; if the width W is 4 mil, and the height S₁ of the parallel line segment is 9.1 mil, the length difference L_{diff} of the zigzagging type delay line is about 10.7696 mil.

In view of the above, in the embodiments, the actual current trend is analyzed to deduce a more accurate method for compensating length and a method for calculating compensation length, thus the compensation length of the zigzagging type delay line in the actual signal path can be more accurately calculated, thereby more accurately designing a differential pair having actual signal paths with equal lengths.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for calculating compensation length of a zigzagging type delay line, comprising:
counting a quantity A of hypotenuse of the zigzagging type delay line;
counting a quantity B of bends of the zigzagging type delay line;
measuring a width W of the zigzagging type delay line;
measuring a height S₁ of a parallel line segment of the zigzagging type delay line; and
calculating an equation
$${L}_{diff} = A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \}$$
length L_{diff} of the zigzagging type delay line.

2. The method for calculating compensation length of a zigzagging type delay line according to claim 1, wherein the zigzagging type delay line comprises a serpentine.

3. A computer accessible storage media, for storing a computer program, wherein the computer program is loaded in a computer system such that the computer system executes the method for calculating compensation length of a zigzagging type delay line according to claim 1.

4. A method for compensating length of differential pair, comprising:
setting a quantity A of hypotenuse of a zigzagging type delay line;
setting a quantity B of bends of the zigzagging type delay line;
setting a width W of the zigzagging type delay line;
calculating a pair length difference L_{diff} formed by the differential pair at a bend;
calculating an equation
$${L}_{diff} = A ( \sqrt{2} - 1 ) ( {S}_{1} - ( 5 W / 6 ) ) + B \{ \sqrt{{[ \frac{W}{5} ( 1 + \sqrt{2} ) ]}^{2} + {[ \frac{W}{5} ]}^{2}} - [ \frac{W}{5} ( 1 + \sqrt{2} ) ] \}$$
for calculating a height S₁ of a parallel line segment of the zigzagging type delay line;
setting the height S₁ of the parallel line segment of the zigzagging type delay line; and
near the bend, disposing the zigzagging type delay line in an inner line of the differential pair.

5. The method for compensating length of differential pair according to claim 4, wherein the zigzagging type delay line comprises a serpentine.

6. A computer accessible storage media, for storing a computer program, wherein the computer program is loaded in a computer system such that the computer system executes the method for compensating length of differential pair according to claim 4.
